(19) United States
(12) Patent Application Publication
(10) Pub. No.: US 2015/0032519 A1
(43) Pub. Date: Jan. 29, 2015

(54) INTERACTIVE ADVERTISEMENT METHOD AND SYSTEM

(71) Applicants: Charles A. BROOKS, Graham, NC (US); Jerry D. STEWART, Elon, NC (US)

(72) Inventors: Charles A. BROOKS, Graham, NC (US); Jerry D. STEWART, Elon, NC (US)

(21) Appl. No.: 14/333,707

(22) Filed: Jul. 17, 2014

Related U.S. Application Data
(60) Provisional application No. 61/857,470, filed on Jul. 23, 2013.

(51) Int. Cl. G06Q 30/02

(52) U.S. Cl. CPC G06Q 30/0209
USPC 705/14.12

(57) ABSTRACT

An interactive advertisement method and system provides a computer generated game or virtual environment with interactive tasks presented to a user and in which user participation is monitored and advertising is presented in conjunction with an interactive task, and in which a user's attention to an advertisement is detected and presentation or awarding of a redeemable reward.

### RELATED APPLICATIONS

This application is a conversion of U.S. Provisional Application No. 61/857,470 filed on Jul. 23, 2013.

### BACKGROUND OF THE INVENTION

1. Field of the Invention

This application relates generally to a method and apparatus for presenting advertisements and, more specifically, to a method and apparatus for providing entertainment to a user and rewarding a user for being exposed to an advertisement.

2. Description of Related Art

Conventional advertisement methods are passive in nature. Advertisements are often played to large audiences during radio and television broadcasts. However, most members of the audience consider such advertisements to be a nuisance, and turn their attention away from the broadcasts until the programmed content returns after the advertisements have concluded.

Such passive advertisement methods may take into consideration the time of day at which the advertisements are broadcast, or even the radio or television programming during which the advertisements will be broadcast. For instance, an advertisement for a child's toy may be likely to be played early on a Saturday morning, during a cartoon or other programming intended for young audiences. Likewise, advertisements for new cars, for example, are unlikely to be broadcast at such a time or during such programming because most viewers are too young to drive or own a car. However, beyond the broad classification of viewers as being too young to drive or old enough to legally hold a driver's license, for example, broadcast advertisements are often not able to be tailored to the specific members of the audience.

3. Summary of the Invention

The present disclosure and related inventions includes methods and systems for interactive advertisement in connection with a virtual environment, such as an interactive, computer-based game. User participation in the game is monitored and one or more advertisements are presented as part of an interactive task that the user can access once a game objective is achieved. A user's attention to the advertisement is confirmed and a reward granted that is redeemable outside of the virtual environment.

As further described in detail in the present disclosure and related inventions, in an exemplary aspect of the disclosure and related inventions there is provided a computer system for encouraging a user to observe, engage, or observe and engage an advertisement, the computer system having at least one non-transitory memory storing computer program code; and at least one processor, wherein the at least one memory and the computer program code are configured to, with the at least one processor, cause the computer system at least to: present the user with a virtual environment in which a game is to be played by the user,

monitor participation of the user in the game, determine that the user is eligible to be presented with an interactive task involving the advertisement once the participation of the user in the game results in a game objective being achieved by the user, grant the user access to the interactive task after the user has achieved the game objective, present the user with the advertisement as part of the interactive task, confirm that the user paid attention to a portion of the advertisement, and grant to the user a reward in the virtual environment for paying attention to the portion of the advertisement, wherein the reward is redeemable at the discretion of the user to be used outside of the virtual environment as legal tender.

These and other aspects and features of the disclosure and related inventions are further described herein in detail with reference to the accompanying drawing figures.

### BRIEF DESCRIPTION OF THE DRAWING FIGURES

The invention may take physical form in certain parts and arrangement of parts, embodiments of which will be described in detail in this specification and illustrated in the accompanying drawings which form a part hereof and wherein:

FIG. 1 shows a schematic representation of a networked computer system for providing a virtual environment including at least one game that a user can participate in to be granted access to an interactive task involving an advertisement;

FIG. 2 shows an illustrative embodiment of a registration interface for creating a user account belonging to a new user;

FIG. 3 shows an illustrative embodiment of a purchase interface presented by a computer system to facilitate the purchase of Game Points by a user;

FIG. 4 shows an illustrative example of a login screen of a virtual environment where a user can enter credentials specific to that user to gain access to games within the virtual environment;

FIG. 5 shows an illustrative example of a game within the virtual environment;

FIG. 6 shows an illustrative embodiment of a game where a game objective has been achieved and an interactive advertising task has been made accessible to a user playing the game;

FIG. 7 shows an illustrative embodiment of a task list including a task that has been made accessible to a user who has achieved a game objective;

FIG. 8 shows an embodiment of an interactive task involving an advertisement and a plurality of questions pertaining to the advertisement that are to be answered by a user to confirm that the user has paid attention to the advertisement;

FIG. 9 shows an illustrative example of a reward interface notifying a user that a reward has been credited to the user's account for successful completion of an interactive task;

FIG. 10 shows an illustrative embodiment of a redemption interface for redeeming at least a portion of an accumulated quantity of rewards of Game Points, for further game play;

FIG. 11 shows an illustrative example of a model for commercializing a system that provides users with an incentive to attentively observe an advertisement;

FIG. 12 shows an illustrative embodiment of a profile interface presented by a computer system to grant an authorized party access to personally-identifying information stored in the user's account;

FIG. 13 shows an illustrative embodiment of the front and back of an EPC card bearing an EPC that can be used to anonymously link a transaction to a user account to earn a reward within a virtual environment; and

FIG. 14 shows an illustrative embodiment of a mobile telephone displaying an EPC encoded as a computer-readable code and in human-readable characters that can be interpreted by the naked eye without the assistance of a computer.

### DETAILED DESCRIPTION OF THE INVENTION

Certain terminology is used herein for convenience only and is not to be taken as a limitation on the present invention. Relative language used herein is best understood with reference to the drawings, in which like numerals are used to identify like or similar items. Further, in the drawings, certain features may be shown in somewhat schematic form.

It is also to be noted that the phrase “at least one of”, if used herein, followed by a plurality of members herein means one of the members, or a combination of more than one of the members. For example, the phrase “at least one of a first widget and a second widget” means in the present application: the first widget, the second widget, or the first widget and the second widget. Likewise, “at least one of a first widget, a second widget and a third widget” means in the present application: the first widget, the second widget, the third widget, the first widget and the second widget, the first widget and the third widget, the second widget and the third widget, or the first widget and the second widget and the third widget.

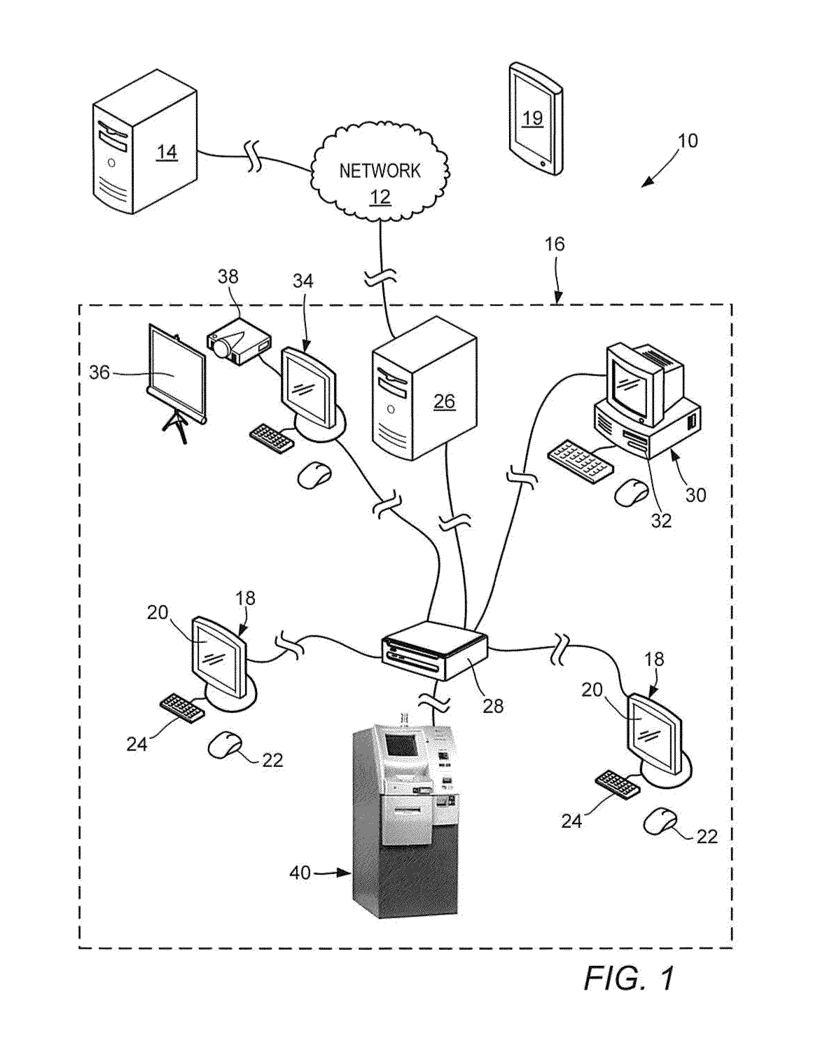

FIG. 1 shows an illustrative embodiment of a computer system 10 for providing a virtual environment including at least one game that a user can play to become eligible to access an interactive task involving an advertisement. The computer system 10 includes a server 14 operatively connected to communicate with a remotely-located site 16 via the communication network 12. The communication network can include a wide area network (“WAN”) such as the Internet, a local area network (“LAN”), or a combination thereof. As shown in FIG. 1, the server 14 is connected to the site 16 via a virtual private network (“VPN”), which is a private network established through primarily public communication infrastructures of the WAN forming the Internet. The VPN can employ tunneling protocols, encryption, hardware firewalls and other security measures to limit unauthorized access to communications transmitted via the network 12 through the VPN. Although the computer system 10 is shown in FIG. 1 and described herein as including a distributed server 14, remotely located externally of the site 16 for hosting content such as at least one of audio, video and a still image to be included in the advertisement over a network, it is to be understood that alternate embodiments of the computer system 10 can include the components described herein implemented as a stand-alone, locally self-contained computer terminal, or distributed locally, over a LAN only. For the sake of brevity, however, the computer system 10 will be described herein as including a remotely-located server 14.

The site 16 can be any location such a brick-and-mortar building including a plurality of general-purpose computer terminals, referred to herein as customer terminals 18, programmed to operate as described herein. The customer terminals 18 include a computer processor executing computer-executable instructions or computer program code stored in a non-transitory memory such as a hard drive, ROM, or other such device. A monitor 20, which can optionally be a touch-sensitive display, or other suitable display device is provided to each customer terminal 18 to present the user with a graphical user interface including motion picture and/or still images providing the appearance of the virtual environment. Each customer terminal 18 can optionally also be provided with an input peripheral such as a mouse 22, keyboard 24, lever (not shown) or other device allowing the user to input an instruction into the customer terminal 18. The customer terminals 18 are operable by users to access the Internet and applications in addition to the games described below.

For the sake of brevity and clarity, the description that follows involves a computer system 10 for providing a virtual environment and hosting a game to be played by users physically present at the site 16. As such, patrons of the site 16 purchase the product Game Points as described below, and can redeem points corresponding to the Points purchased to perform a variety of activities in individual and social entertaining games using customer terminals 18. Individual games can involve a user participating in a single player game, competing against him or herself, or otherwise participating without the need for another competitor. Social entertaining games, can involve a social aspect, where users can interact with or compete against each other within the virtual environment or outside of the virtual environment, in the real world. However, it is to be understood that the virtual environment can be accessed by computing terminals located externally of the site 16. Further, the customer terminals 18 are described herein as general purpose computers programmed to operate as described herein, but the present disclosure encompasses other types of electronic devices such as portable terminals 19 (e.g., tablet or laptop computers, cellular and “smart” telephones, personal digital assistants, etc. . . . ). Thus, the virtual environment and/or the interactive tasks involving the advertisement described herein can be presented to users via the customer terminals 18, the portable terminals 19, or a combination thereof.

The site 16 can also include a SQL server 26 that is local (i.e., located at the same geographic location, or inside the brick-and-mortar building of the site 16) and operatively connected to the customer terminals 18 over a LAN to serve content to be included in the virtual environment and optionally the games played by a plurality of users at the site 16. The LAN can include a network switch 28, router and/or other networking components known in the networking art to facilitate secure communications between components of the LAN located at the site 16. One or more point of sale (“POS”) terminals 30 can also be located at the site 16 to allow users to purchase a product and/or service, thereby obtaining credits (Game Points) that can be utilized at the site 16 via the customer terminals 18. The POS terminal 30 can be a self-serve vending apparatus, such as an automated terminal that optionally includes a bill acceptor 32 for receiving legal tender such as paper bills, coins, and/or other form of payment, a scanner for accepting credit/debit card payment, or a combination thereof for the purchase of Game Points. According to alternate embodiments, the POS terminal 30 can be a manual cash register, operated by a teller at a window at the site 16 where users can make purchases with cash, credit and/or debit cards, etc. . . . , for Game Points.

One of the purchases users can make using the POS terminal 30 is Game Points. Game Points 96 are not legal tender (e.g., have no monetary value recognized by a government entity), and can optionally have no monetary or other value to parties that are independent of the site 16, or to a party that is not affiliated with the computer system 10 or the virtual environment including the games and interactive tasks described herein. The Game Points 96 can optionally have no monetary value outside of their use for representing the amount of game plays remaining as described herein, and can optionally be not redeemable for anything of value other than participation in the games or other use of the virtual environment described herein.

A community terminal 34 can also optionally be included as part of the LAN at the site 16 to broadcast information pertaining to a plurality of different users and foster competition between those users. For example, the community terminal 34 can transmit content (e.g., still images and/or animated displays) to be displayed on a large-format, publicly-viewable (by patrons at the site 16) display 36. The display 36 is shown in FIG. 1 as a screen on which the content to be displayed is projected by a projector 38 communicating with the community terminal 34. However, alternate embodiments of the display 36 can include a LCD, plasma or other such broadcast display that is suitably large to allow for public viewing of the content displayed thereon by a plurality of users at the site 16. Regardless of the type of display 36 utilized, the display 36 can broadcasts content indicating progress made by each of a plurality users in the game, interactive tasks, etc. . . . For example, the display 36 can broadcast a leaderboard, or scroll through multiple screens to show the ranking of the top 25 users ranked based on achievement points as described below, tasks completed, etc. . . . . This inter-active social behavior reinforces the concepts of the social gaming environment.

The site 16 can also include a kiosk 40 that can communicate with remotely-located computer systems and/or servers such as server 14 to dispense cash (e.g., US dollars or other legal tender or value exchange system or medium or unit of account, such as digital currency such as Bitcoin™ or the like), pre-loaded credit/debit/gift cards and other prizes having real-world value based on the rewards stored in a user's account. According to an embodiment, the kiosk 40 can function as an automated teller machine that dispenses cash, checks, payment cards, or other forms of payment in legal tender as a form of redemption of rewards earned in the virtual environment for successfully completing interactive tasks and stored in the user's account. In other words, the kiosk 40 can function as a type of automated teller machine with a dispenser that dispenses cash from a secure vault in the kiosk 40, for example, based on the value of rewards in the user's account. The legal entity that maintains the kiosk 40 and the value of rewards stored in the user's account that can be redeemed for legal tender or other valuable form of payment can optionally be different than the legal entity that maintains the Game Points 96 in the user's account and controls redemption of the Game Points 96 for game participation in the virtual environment.

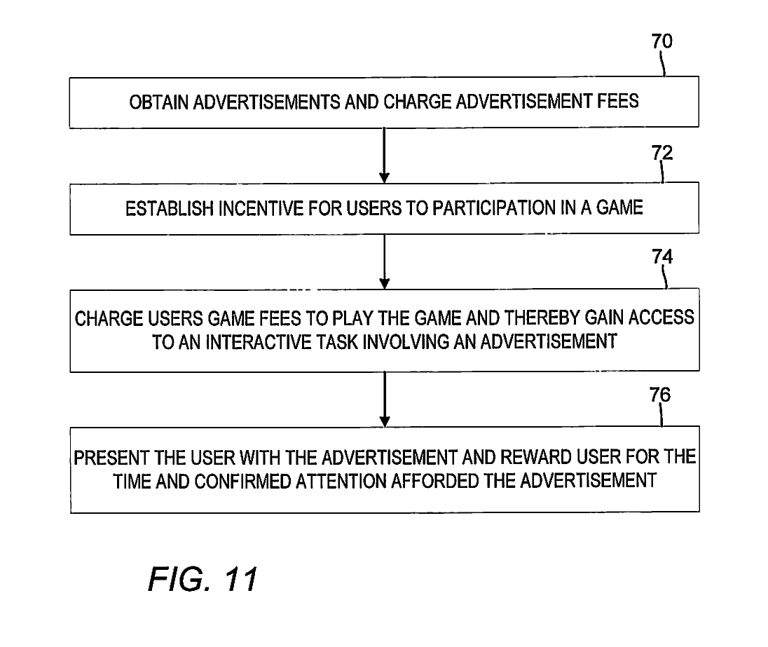

A general model for commercialization of the computer system 10 disclosed herein is schematically represented in FIG. 11. According to such a model, revenue can be generated from advertising clients willing to pay to have their advertisements presented to users who have an incentive to attentively observe such advertisements. At step 70 advertisements are obtained from such advertising clients who are charged fees for the opportunity to have their advertisements presented to the users of the computer system 10. The fees charged, but not limited to can optionally vary based on the extent to which users interact with the advertisements and possibly the advertising clients themselves as described in detail below. Users of the present system 10 are provided an incentive at step 72 to participate in games by competition against their peers. For example, users can be awarded achievement points in response to reaching certain goals within the game. These achievement points can be non-redeemable and used simply to rank users with respect to each other based on their participation in the games. Thus, users will be encouraged to participate in the games for the social entertainment value that results from such competition. Trivial prizes such as milestone pins or other trinkets indicating the users' progress within a game can also optionally be presented to those users who earn achievement points. They can also be purchased by the customer to further heighten a user's game play experience. For example, the user can purchase a so-called “cheat” that includes a lapel pin and advances the user's progress in a game to a point beyond the point the user would have been without purchasing the cheat. The prices of such tokens are of limited monetary value and serve merely as trophies for the users to exhibit their accomplishments within the game, further incentivizing the users to actively participate in the games.

However, since Game Points 96 are deducted from the user account for the user's participation in the game, and such Game Points 96 are purchased by the user, additional revenue is generated through the sale of Game Points 96 at step 74. The sale of Game Points 96 will also be encouraged to assure users that they will have sufficient access to the game to be granted access to an interactive task that, when successfully completed, results in a reward being granted to the user. Since the eligibility of the user to access the interactive task is earned over the course of game play, users will be encouraged to purchase sufficient Game Points 96 to play the game long enough to satisfy the game objective required to gain access to the interactive task. The interactive task can be restricted, meaning that the user is unable to perform the interactive task prior to reaching the game objective.

The game objective can be to establish sufficient progress required by the game to become eligible to gain access to the interactive advertising task described below. If a user successfully completes the task, the user is given a reward that is saved in the user account belonging to that user. The reward given to the user is stored in the user account as a virtual reward that has no monetary value outside of the virtual environment in its current form, when awarded to the user. However, such rewards can eventually be accessed by the user to be turned into legal tender or other items of value such as payment of the monthly telephone bill, gift cards, vacation vouchers, etc. According to alternate embodiments, the rewards can also be redeemed for additional Game Points 96 within the virtual environment. According to alternate embodiments, the reward given to the user for successful completion of the interactive advertising task can be legal tender, when awarded to the user and credited to the user account or otherwise distributed to the user. Unlike games of chance, the interactive tasks to which the user is granted access require skill on the part of the user to be successfully completed as a condition for receiving the reward. For example, the user can be presented with an advertisement at step 76 as part of the interactive task. However, the user must pay sufficient attention to the presented advertisement to comprehend its contents. The interactive task also includes a test, which requires one or a plurality of questions about the content of the advertisement to be correctly answered by the user before the user is given the reward.

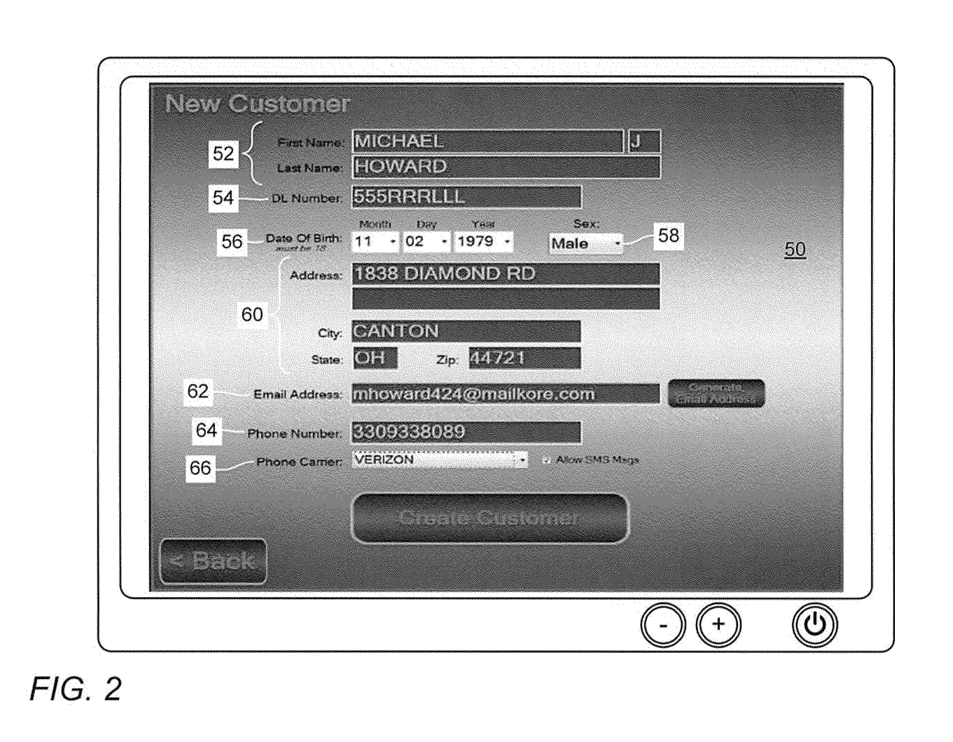

More specifically, users can create new user accounts upon arrival at the site 16 by approaching the teller at the window at the site 16 and providing personal and demographic information about themselves. This information can be entered into the computer system 10 via a registration interface 50, which can optionally be displayed by the POS terminal 30 as shown in FIG. 2. For embodiments where the teller enters the information specific to the user, appropriate documentation can be requested to assure the accuracy of information provided by the user. According to alternate embodiments, however, the registration interface 50 can optionally be displayed by the monitor 20 provided to the customer terminal 18, allowing the user to enter the information himself. Examples of the types of information to be entered for association with the user account being opened include, but are not limited to, at least one of the user's: name 52, driver's license number 54 and/or state, date of birth 56, sex 58, residential mailing address 60, personal email address 62 used by the user for receiving and sending electronic communications within the virtual environment without a desire on the part of the user to remain anonymous (e.g., the user may use a portion of his name, such as last name and first initial, as part of the personal email address), phone number 64 (home and/or mobile number), and phone carrier 66. Here also personal lifestyle questions may be asked and answered. Example: Are you a pet owner? What kind of car do you drive? What is your annual salary? Where do you vacation? These are all profiling questions to better link the user to advertisers and advertisements that are likely to be of interest to, or at least pertinent to the user and that can be presented to the user as part of the interactive advertising tasks described herein. Tailoring the advertisements presented as part of the interactive advertising tasks to the specific users improves the likelihood that the extent of the interaction between the user and the advertiser will be elevated (e.g., the user will actually purchase an advertised product instead of merely watching the advertisement) as described below. Based at least in part on the tailored advertising opportunity to get their advertisements in front of an audience more likely to purchase the advertised goods and/or services as opposed to broadcasting an advertisement, advertising clients may pay a premium for this opportunity. Thus, advertising clients can be incentivized to pay premium advertising fees compared to the fees paid for broadcast advertisements.

A relationship may be established between an operator of the virtual environment and various vendors, who may also be the advertising clients. The cellular telephone carrier is one such example, and rewards obtained within the virtual environment for successful completion of an interactive task can optionally be redeemed for payment of the user's monthly cellular phone bill. Having this information (phone carrier) available from the user account allows an administrator affiliated with the virtual environment to determine whether such an offer may be of interest to the user who owns the user account being opened. Further, the information available in the user account can optionally be utilized to select appropriate advertisements to be presented to that user as part of the interactive task. For example, advertisements of special offers available to existing customers of Verizon (entered as the phone carrier for the embodiment shown in FIG. 2) may be of interest to the user, whereas advertisements of special offers available to existing customers of AT&T would not. As another example, a male, between the ages of 25 and 35 is more likely to be presented with an advertisement for a certain make and/or model truck than a female user who is 50+ years old. Generally speaking, the information stored in the user account can be considered in targeting users with specific advertisements.

The user is also assigned an Electronic Personality Code (hereinafter “EPC”) that can be the user's identification in the virtual environment. The EPC can be a randomly generated code including at least one of an alphabetic character, a number, and a symbol that allows the user to be distinguished from other users in the virtual environment, yet remain anonymous to the advertising clients within the virtual environment, and optionally the real world outside of the virtual environment. The EPC can be linked to the user's account, allowing the EPC to be referenced or otherwise used in the virtual world and/or real world (e.g., in a society populated by human beings) and the activity involving the EPC, or a result thereof, associated with the respective user's account. For instance, a list of EPCs belonging to users who have viewed a particular advertisement for a Chevrolet truck can be maintained, and even made available to, at least one of General Motors, the dealership closest to each respective user where that truck can be purchased by those users based on the personal information provided by the users when creating the user account, and a third-party who sells that truck used. Such parties can optionally be permitted by the computer system to transmit special offers and/or incentives to the user by addressing such advertisements to the EPC corresponding to the target user. According to alternate embodiments, statistics pertaining to users (e.g., quantity of users, geographic location of users who were presented with an advertisement, generalized demographic information such as average age of users who were presented with their advertisement, etc. . . . ) can be provided to advertising clients instead of, or in addition to the EPC of such users. But regardless of how the EPC of each user is used, the EPC can represent the anonymous presence of the user within the virtual environment. Accordingly, users can approach advertising clients by actively opening advertisements, websites, etc. . . . belonging to the advertising clients without fear of subjecting themselves to a bombardment of advertisements (e.g., junk email, telemarketers, etc. . . . ) that could possibly result if the user's personal identity and/or contact information became known to the advertising client without the identity protection afforded by the EPC.

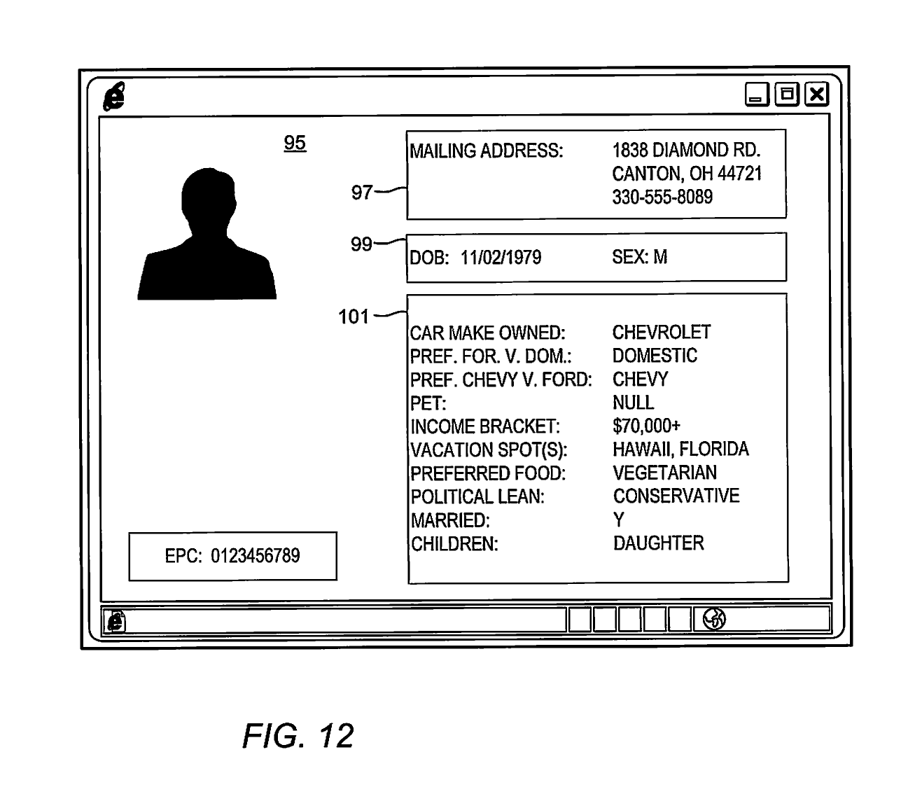

Although the EPC and other personally-identifying information is not readily available to the advertising clients, such information is maintained by, or on behalf of, and is accessible to the proprietor of the virtual environment. Thus, the EPC can be used to maintain the anonymity of the user in the virtual environment, but communications intended for the users can be facilitated by the computer system and optionally the proprietor managing the virtual environment. For example, as shown in FIG. 12, a profile interface 95 can be made accessible by the computer system to an authorized party permitted to obtain any of the information stored in the user's account. The profile interface can include contact information 97 and personal information 99 (e.g., date of birth and sex) specific to the affiliated user.

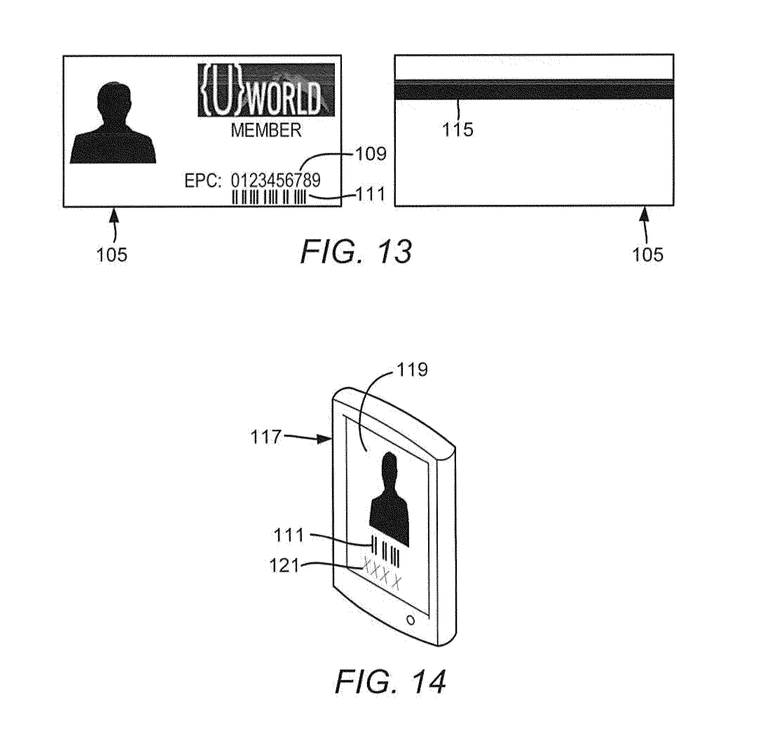

Additionally, collected data 101 stored in the user's account can be made viewable, and can include a variety of information that can be used to identify advertisements for goods and/or services that will likely resonate with the user. For instance, and as discussed below, transactions made by the user in the real world can be linked to the user account by documenting the user's EPC as being related to the transaction. Thus, if the user purchases a pizza at a restaurant and uses a coupon linked to the user's EPC (e.g., the EPC can be printed on the coupon or encoded in a barcode appearing on the coupon so that the EPC is read by a computer when the barcode is, etc.) or otherwise provides his EPC to the restaurant, the transaction can be saved in the user's account so future advertisements by that restaurant can be presented to the user as part of the interactive advertising task discussed below. According to alternate embodiments, the user can be issued a card 105 such as that shown in FIG. 13, including the EPC in at least one of a human readable form 109 (e.g., letters, numbers, symbols, etc. . . . that can be interpreted with the naked human eye), a computer readable form such as a barcode 111 that can be interrogated and read by a computer equipped with a compatible scanner. Another embodiment of a computer-readable format encoding the EPC is a magnetic stripe 115 appearing on the back surface of the card 105 as shown in FIG. 13.

According to alternate embodiments, the user can utilize a mobile communication terminal 117 such as a cellular telephone or smart phone, shown in FIG. 14, to convey the EPC to a vendor as part of a sales transaction to link information related to such a transaction to the user account of the respective user. According to such embodiments, the user can display a computer-readable code such as the barcode 111 on the display screen 119 of the mobile communication terminal 117, from where it can be scanned by a vendor using the appropriate barcode scanner. Alternately, the EPC can be displayed as human-readable characters 121 and/or wirelessly transmitted via a Bluetooth or other suitable communication channel.

The card 105 and/or the mobile communication terminal 117 can optionally include a photograph of the user to be presented to the vendor to authenticate the user as the person who is actually owns the EPC. However, according to any of the embodiments, personally identifying information is omitted to avoid conveying the actual identity or any personal contact information of the user to the vendor.

Another way information can be entered into the collected data 101 portion of the user's account is for the user to be presented with a survey after a related transaction is stored in the user's account. If the user's feedback submitted as part of the survey is negative (e.g., the user did not like the pizza), this can also be stored in the user's account so future advertisements presented as described herein can exclude advertisements from that restaurant. Other surveys can ask the user to compare two or more products and identify a favorite from the group. Again, this information is stored in the user account belonging to that user to select future advertisements to be presented to the user as part of the interactive task. Yet other surveys can ask the user to answer a question related to a societal issue or policy, or politics in general. Based on this information, the user's political leaning can be surmised, and topics of interest identified to select advertisements to be presented to the user.

The user can volunteer any of the information included in the collected data 101 of FIG. 12, or can supply any of this information as an answer to a question (either regarding the advertisement presented or independent of the advertisement presented) submitted as part of the interactive advertising task, for example. But regardless of how the information is entered into a user's user account, the EPC allows this information to be factored into a selection of advertisements that will likely resonate with the user to be presented as part of the interactive advertising task as described below.

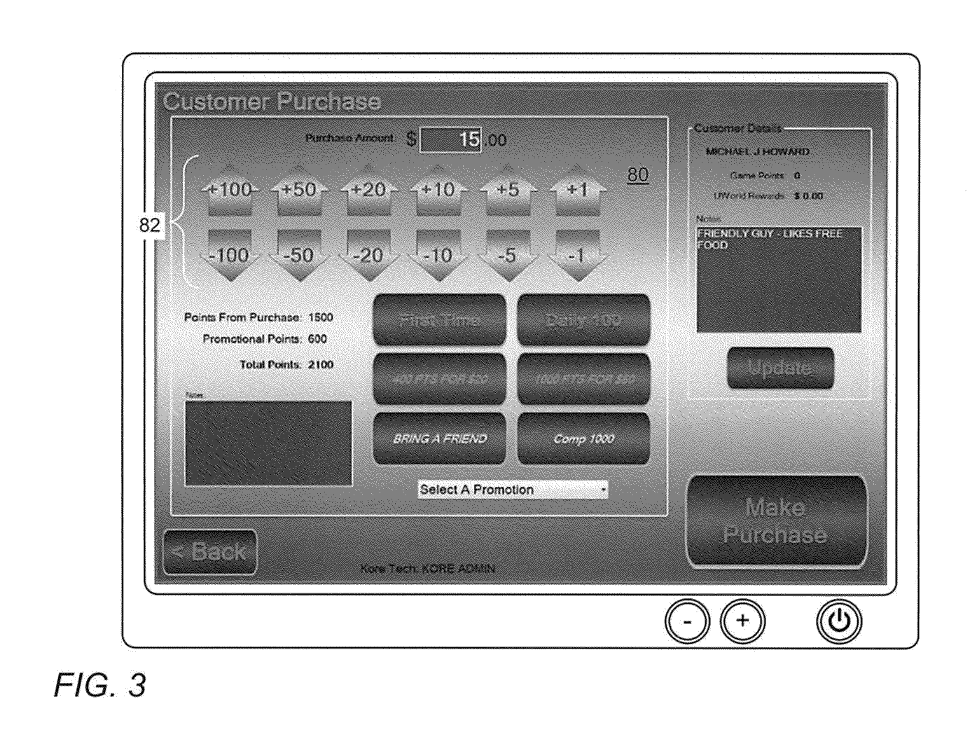

Once the user is registered and a user account has been created, Game Points 96 can be purchased and credited to the user's account via the purchase interface 80 shown in FIG. 3. The purchase interface 80 includes a variety of denomination controls 82 that can be manipulated by the teller to select the quantity of Game Points 96 the user desires to purchase. Game Points 96 can correspond in value to the dollar amount the users spend. For example one game point can be awarded for every cent paid by the user. Game Points 96 that have been purchased and credited to the user account can optionally not be redeemable for anything other than game points for participation in the game within the virtual environment.

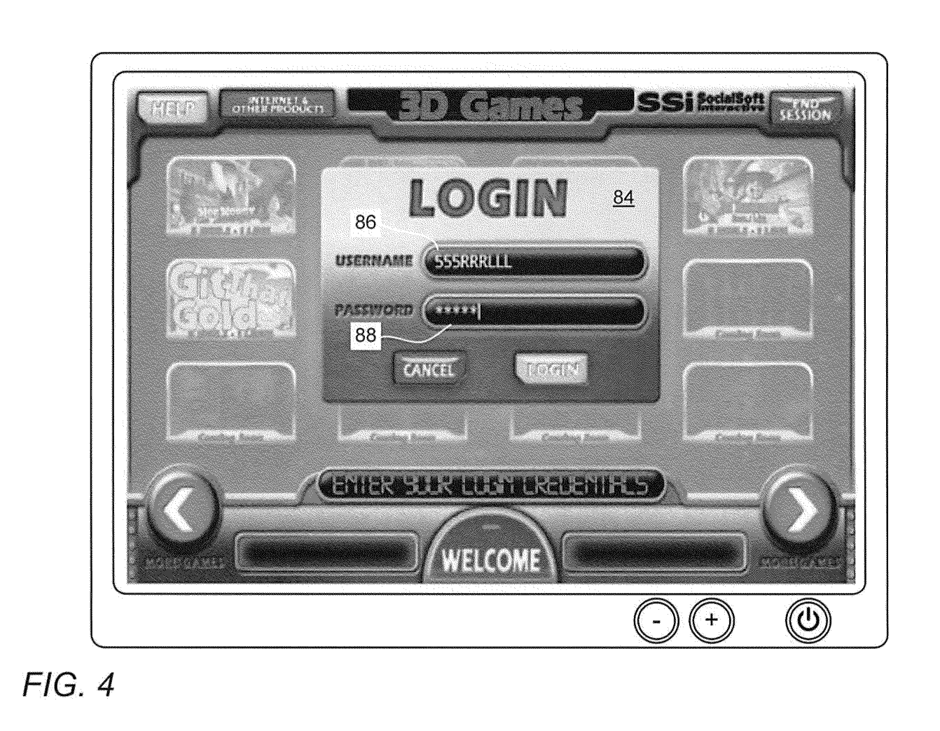

With the user account open, the user can proceed to one of the customer terminals 18 within the site 16. A login screen 84, shown in FIG. 4, is presented to the user by the display 20 of the customer terminal 18. The username 86 and password 88 are entered into the appropriate fields to be submitted for verification. If verified as being current and authentic, the username and password combination created during registration of the user grants the user access to a plurality of games within the virtual environment that would be restricted, or inaccessible without a user account and the proper login credentials.

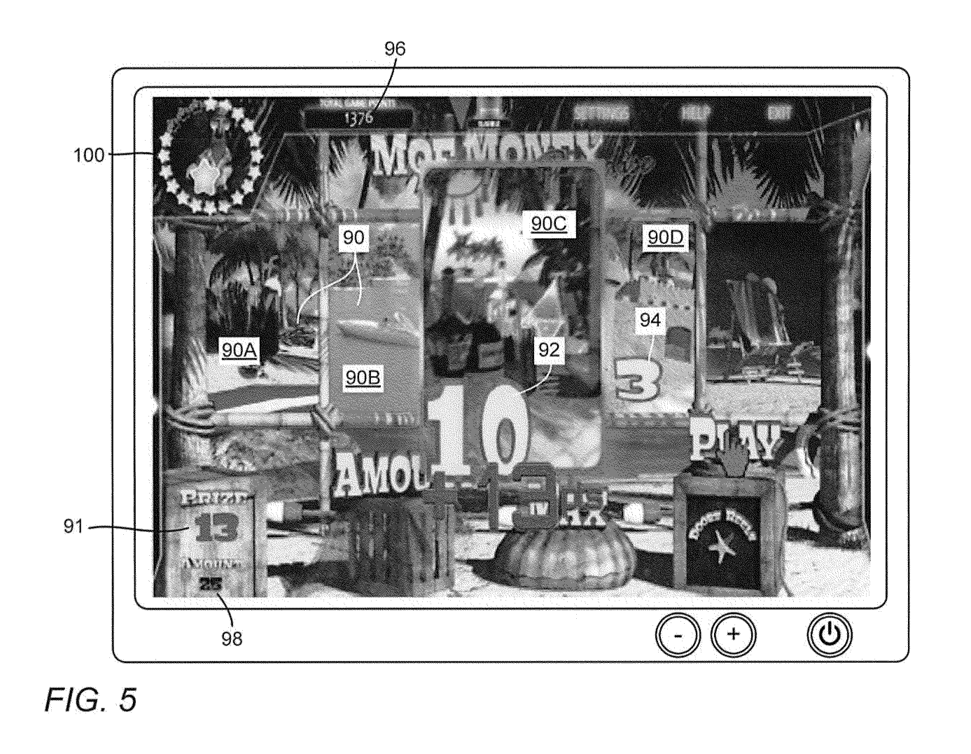

FIG. 5 shows an illustrative embodiment of a game within the virtual environment displayed by the display 20 of a customer terminal 18 to be played by the user in an effort to gain access to an interactive task. Any entertaining game that can be played by the user to accumulate credits, score or other indicator of progress made for gaining access to the interactive task over time is within the scope of the present disclosure. However for the illustrative embodiment shown in FIG. 5, a game during which tiles 90, possibly containing winning entries, are revealed is discussed for the sake of brevity. Each tile 90 can have a decorative appearance and optionally include a graphical icon indicative of the winning tile that, when revealed, results in an awarded being conveyed to the user and stored in the user account belonging to the user. As shown in FIG. 5, tiles 90A and 90B are merely decorative and do not include the winning icon. Tile 90C, however, includes a number 92 indicating the total number (10 in the present example) of Game Points 96 awarded to the user when that tile 90C is revealed. Tile 90D also includes a number 94 indicative of the number (3 in the present example) of Game Points 96 to be awarded to the user as a result of revealing that tile 90D. The sum 91 of the numbers 92, 94 revealed during a single game play is indicative of the total number (13 in the present example) of Game Points 96 awarded to the user and saved in the user account for that game play. The awarded Game Points 96 are added to existing Game Points 96 already stored in the user account. According to the present example 13 total Game Points 96 are credited to the 1,376 Game Points 96 already in the user account for the game play shown in FIG. 5.

Each game play necessarily involves the deduction of a predetermined quantity 98 of Game Points 96 from the user account. For the game play shown in FIG. 5, the user has elected to deduct 25 Game Points 96 for each game play, but this value can be varied as desired by the user between game plays. The sum 91 of Game Points 96 awarded as a result of a winning tile 90C, 90D being revealed can optionally be proportional, or at least related to the quantity 98 of Game Points 96 deducted from the user account for that particular game play. Further, a greater number of Game Points 96 can occasionally be awarded to the user than the number of Game Points 96 deducted for a given game play. But regardless of the quantity 98 of Game Points 96 deducted, the Game Points 96 stored in the user account will exhibit a generally decreasing trend over time according to an algorithm used to determine the frequency at which winning tiles 90C, 90D are to be revealed and the denomination of those winning tiles 90C, 90D. For the particular game play shown in FIG. 5, the net result was a deduction of 12 Game Points 96 from the user account once the 13 Game Points 96 won have been subtracted from the quantity 98 of 25 Game Points deducted. The user can continue to participate in the game so long as the user account has a sufficient number of Game Points 96 required to perform at least one game play. Once the entire number of Game Points 96 has been depleted from the user account, the user can optionally purchase additional Game Points 96 as described above.

In the game according to the present example, a progress indicator 100 alerts the user to the progress being made in becoming eligible to access the interactive task. When Game Points 96, the nonmonetary star icons, or a combination thereof are awarded to the user, or when the user otherwise makes progress in the game toward the game objective that must be achieved to gain access to the interactive advertising task, the progress indicated by the progress indicator 100 advances further toward a value that, once reached, grants the user access to the interactive advertising task. Icons other than the numbers 92, 94 representing the Game Points 96 awarded can occasionally appear on winning tiles 90C, 90D. For example a single star or a plurality of stars can appear on one or more winning tiles 90C, 90D. Such icons, when present, indicate that the user will be awarded a corresponding number of stars on the progress indicator 100, which includes an accurate pattern of stars that are gradually obtained, towards becoming eligible to access the interactive task.

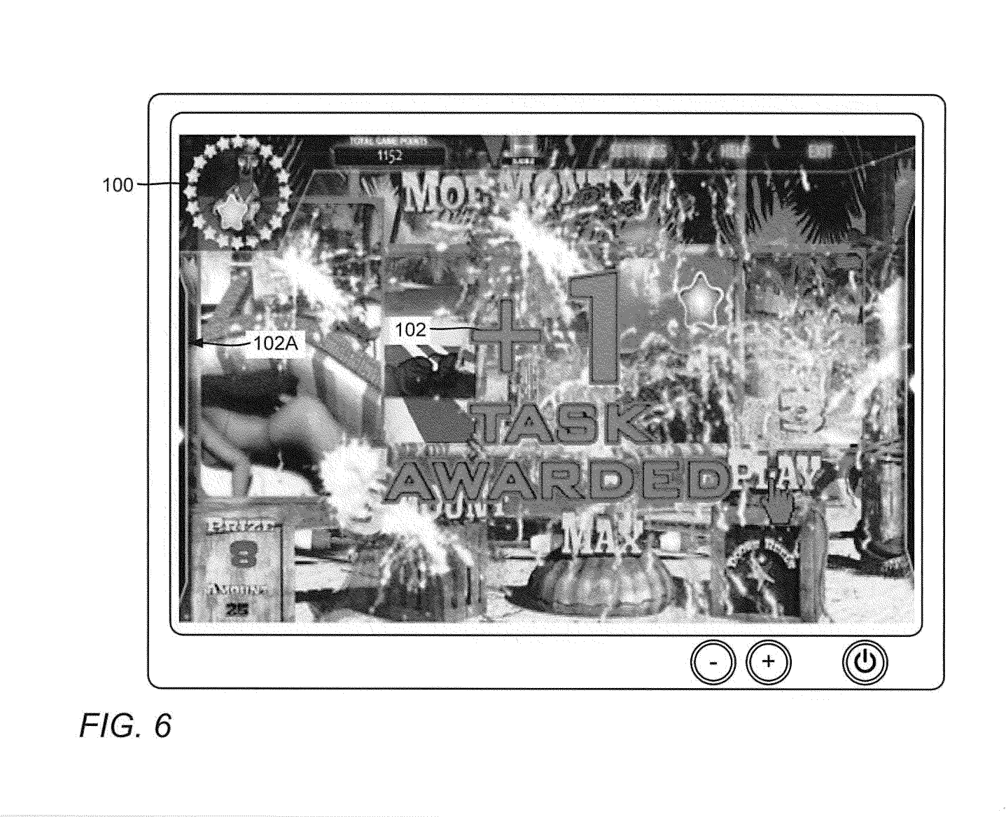

Once the entire ring of stars provided to the progress indicator 100 has been completed according to the present example, the interactive task is made available to the user, and a corresponding display 102 shown in FIG. 6 is presented by the customer terminal 18 to the user. At this time, the interactive task is made accessible to the user so the user can elect to continue playing the game in an effort to gain access to additional interactive tasks, or elect to perform the interactive task to which the user has been granted access. Before achieving the game objective which, in the present example is to obtain all of the stars making up the progress indicator 100, the interactive task made accessible to the user is inaccessible. To access the interactive task, the user can select a side panel corresponding display 102A using the mouse 22 provided to the customer terminal 18 or otherwise select a suitable option displayed by the monitor 20 of the customer terminal 18.

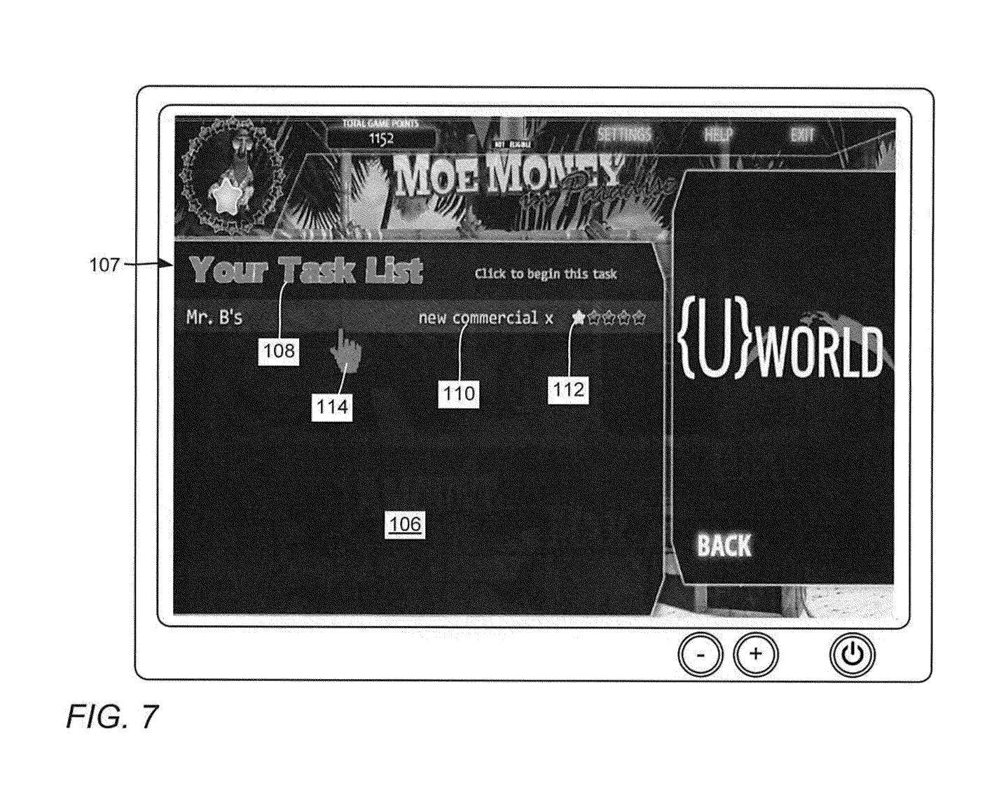

In response to an election by the user to access the interactive task after the progress indicator 100 indicates that the user has achieved the game objective, the customer terminal 18 presents the user with a task list 106, an embodiment of which is shown in FIG. 7. The task list identifies the interactive tasks 107 available by name 108 and provides a brief description 110 of the type of advertisement involved. A rating 112 is also assigned to each task to indicate the potential value of the reward the user can earn for successfully completing each task 107. For the embodiment shown in FIG. 7, a single star rating is indicative of an interactive task 107 for which the user earns a reward with a relatively-low value compared to another task having a rating 112 of more than one star. The rating 112 assigned to each task can optionally be at least one of: randomly selected, selected based on the quantity of Game Points 96 deducted from the user account for each game play as described above, selected based on the game(s) played to gain access to the task 107, and selected based on any other factor desired to influence the value of the reward that can potentially be earned by the user for successfully completing the task 107.

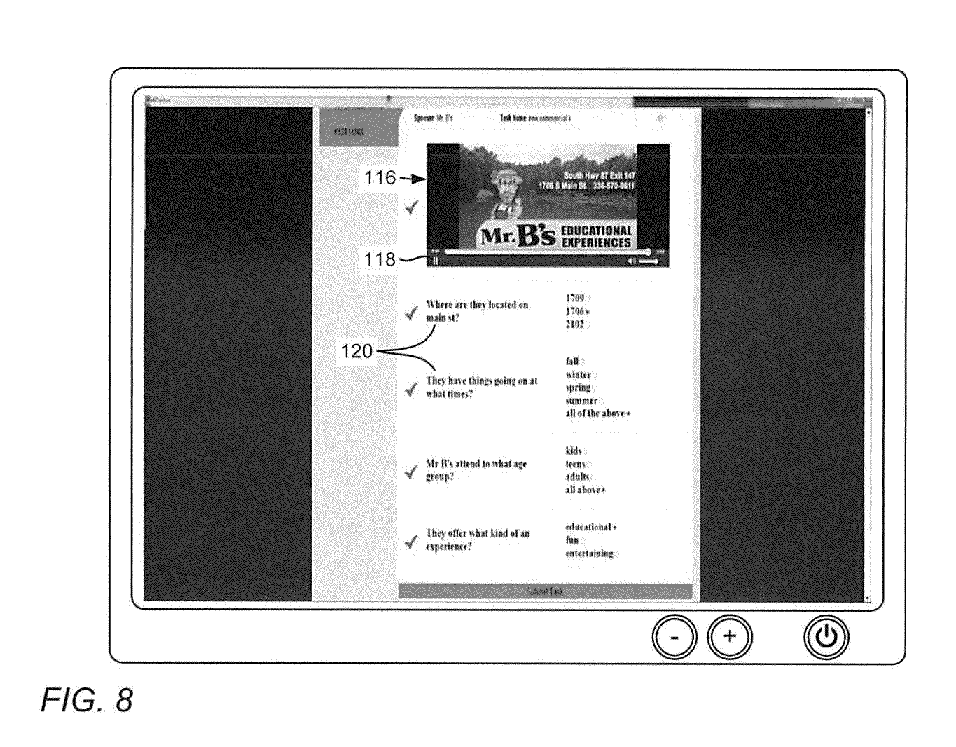

The user can select the task 107 to be performed using a cursor 114 controlled by the mouse 22 provided to the customer terminal 18 to cause the advertisement 116 to be presented to the user as shown in FIG. 8. Selection of the task 107 can optionally direct the user to a website where the advertisement 116 is available to be presented located outside the portion of the virtual environment where the game is played from. For instance, the portion of the virtual environment where the games are played can be operated or maintained by, or on behalf of, or otherwise affiliated with a first legal entity and the website on which the advertisement 116 is available can optionally be operated or maintained by, or on behalf of, or otherwise affiliated with a different legal entity. The two legal entities, although distinct, can optionally be unrelated, or co-owned by a common parent entity or otherwise related. The website can optionally be hosted by the server 14 that serves content to the customer terminal 18 over the communication network to present the advertisement 116 to the user, or the website can be hosted by another server unrelated to the proprietor of the site 16. Further, accessing the website on which the advertisement 116 is located from within the virtual environment including the games can optionally result in the user automatically being logged into the website based on the login credentials (e.g., username and password combination) entered into the login interface 84 as described above. According to such an embodiment, it is unnecessary for the user to separately log into the website, or otherwise enter the same or different login credentials, after having logged into the virtual environment to play the games.

Regardless of how the website or other location where the advertisement 116 resides is accessed, the user can manipulate the appropriate control 118 to initiate playback of the advertisement. The advertisement can include at least one of a motion picture video, a still image, an audible message, and other content used in the advertisement of a good and/or service offered by third-party.

Once the presentation of the advertisement 116 is complete, at least one, and optionally a plurality of questions 120 related to the content of the advertisement 116 is/are presented to the user on the website where the advertisement 116 is located. The questions 120 can optionally be multiple-choice, or in any other desired form. Further, the questions 120 can ask the user about details about the advertisement 116 to confirm that the user has not only observed the advertisement 116, but also paid attention to and comprehended the substance of the advertisement 116. For example, the questions can ask the user to provide information relating to the location of the entity offering a product and/or service that was the subject of the advertisement 116. According to alternate embodiments, the questions 120 can ask the user about a promotional event being sponsored by the party offering the good and/or service advertised.

According to alternate embodiments, the questions 120 can solicit an answer from the user unrelated to the advertisement 116, optionally in addition the answers pertaining to the advertisement 116. The questions unrelated to the content of the advertisement 116 can be asked of the user in an attempt to extract additional information about the user that would allow the computer system 10 to more-accurately identify and present advertisements 116 for goods and/or services that are genuinely of interest to the user. For instance, although the advertisement 116 appearing in the embodiment shown in FIG. 8 is a commercial for educational services, the user could be asked to identify a favorite type of food from among a plurality of presented options. The answer provided by the user to this question can be stored in the user account or at least in association with the user so future advertisements for restaurants serving the food selected by the user can be presented as part of a subsequent interactive task 107 to which the user is granted access. Thus, the supplemental information about the user that would otherwise not be included in the user account or otherwise associated with the user can be considered in the selection of content for future advertisements 107 to be presented to the user.

When a user elects to be presented with an advertisement 116 this represents a minimal, initial interaction between the user and the advertisement 116. Correctly answering the questions 120 concerning the advertisement 116 represents an additional step in the interaction, elevating the interaction to a greater extent than simply being presented with the advertisement 116 without correctly answering the questions 120. Likewise, for the illustrated example of the advertisement 116 in FIG. 8, the advertisement 116 includes the address of the entity offering the educational services that were the subject of the advertisement 116. While logged into the customer terminal 18, the user may elect to open a web browser application and actively initiate a search via a search engine (e.g., Google, etc. . . . ) in an attempt to learn the actual physical location of that entity. Alternately, the user may elect to conduct a similar search, using the search engine, for the name of the entity which is “Mr. B's” in the present example. Such searches actively initiated by the user while logged into the customer terminal 18 are examples of interacting with the advertisement 116 to a greater extent than simply viewing the advertisement 116 or even viewing the advertisement 116 followed by correctly answering the questions 120.

To further increase the extent of the interaction between the user and the advertisement 116, the user can be presented with a coupon or coupon code for a particular vendor/product/service through the virtual environment. The coupon received can be stored in the user account affiliated with the EPC of the user, allowing the user to remain anonymous to the vendor yet still qualify for a reward as a result of receiving the coupon in the virtual environment. The coupon or coupon code can be used by the user along with the EPC discussed above toward the purchase of a good or service and have that purchase stored in the user account to document this interaction and qualify the user for a reward as a result. Receiving a coupon or coupon code infers that the user is more likely to purchase the corresponding good and/or service than if the user had not received the coupon or coupon code. Getting the coupon or coupon code in the possession of a user with a genuine interest in the corresponding goods and/or services discounted as opposed to blanket broadcasting such a discount may be considered by the proprietor to increase the likelihood of a sale. Again, the extent of the interaction is increased as a result of receiving the coupon and/or coupon code.

Another example of increasing the extent of the interaction between the user and the advertisement 116 includes a visit by the user to a website of the proprietor of the good and/or service featured in the advertisement 116. The advertisement 116 can optionally also include or otherwise be accompanied by a uniform resource locator (“URL”), hyperlinked object or other item that, when selected, directs the user to the proprietor's website over the communication network 12, where additional information concerning the advertised good and/or service can be retrieved. According to alternate embodiments the user can manually enter the URL corresponding to such website in the address field of a Web browser application running on the customer terminal 18. Regardless of whether the hyperlinked object is selected or the URL of manually entered by the user, such events are considered an affirmative act by the user expressing an interest in the good and/or service advertised. Accordingly such an event further increases the extent of the interaction between the user and the advertisement 116.

Furthermore a reward can be stored in the user account belonging to the user as a result of offsite activities at the advertisers store, place of business or other location, for example. More personal visibility of the user at the brick-and-mortar locations of the vendor can result in yet a higher reward amount being given to the user for such an offsite visit interaction, which encourages both the user and the advertising client to participate in the rewards program. Yet another example of increasing the extent of this interaction can involve the purchase of the product and or service that was the subject of an advertisement from the advertising client. Such a purchase can optionally be conducted while the user is logged into the virtual environment or occur during a personal visit by the user to the proprietor of such good and/or service. For transactions conducted during a personal visit the user can optionally provide the proprietor with credentials identifying user as being a member of the virtual environment or, after completion of such a transaction, enter information related to the transaction into the virtual environment to associate the transaction with the user account. For example, the serial number of the purchased item can be entered into the virtual environment along with a transaction number issued by the proprietor to establish that such a purchase was made by a member of the virtual environment and facilitated by the advertisement. This transaction can also be associated with the user account owned by the user who made the purchase. A coupon or coupon code discounting the purchased good and/or service can optionally be provided with a unique identifier to document the fact that such a purchase involved the redemption of the coupon and/or coupon code obtained by the user within the virtual environment.

As the extent of the interaction between the user and the advertisement is increased the amount owed by the proprietor as an advertising fee for presenting the advertisement within the virtual environment increases due to the certainty that the advertisement 116 played a role in the purchase assumed as a result of the extent of the interaction. At least a portion of the increased advertising fee can optionally be contributed to the rewards accumulated in the user account of the user for correctly answering the questions pertaining to the advertisement 116. Under such an arrangement, users are provided an incentive to increase the extent of interactions advertisement 116 within the virtual environment, thereby also making the prospect of advertising to willing observers within the virtual environment more attractive to advertising clients, who may be willing to pay more as a result. This increased attraction is in addition to the appeal of targeting users with a genuine interest in the goods and/or services being advertised.

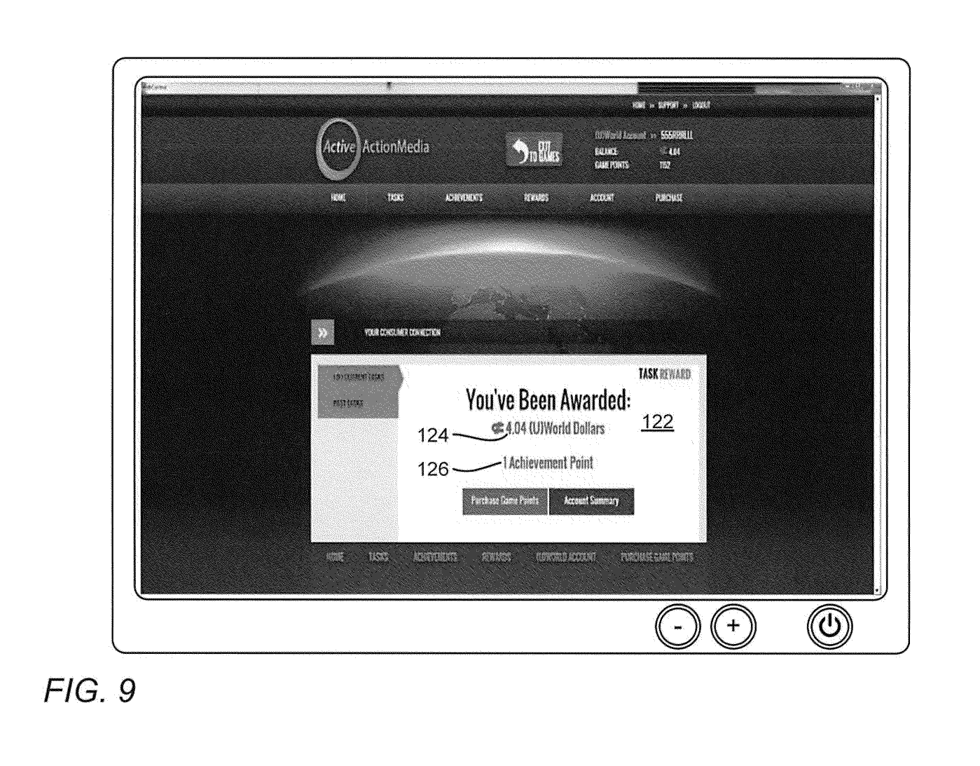

In response to correctly answering the questions 120 concerning the advertisement 116 the user is notified of the reward granted as a result in FIG. 9. For the present embodiment, a reward window 122 is presented on the website where the questions 120 were answered. A reward value 124 is expressed as a form of virtual currency that can optionally be not legal tender when awarded, optionally having a meaningful value only within the virtual environment, but can be redeemed for legal tender for use outside of the virtual environment. One benefit of giving rewards in the form of the virtual currency is that rewards can be earned by the user for various different interactions and activities as described herein, yet each reward resulting from the different activities accumulates as a currency common across all advertising clients. In other words, the user can be given a reward for viewing an advertisement for a particular automobile manufacturer, and another reward for buying food at a grocery store that is independent of the automobile manufacturer. Although the rewards are earned for interactions with different, unrelated entities, they accumulate into larger sums and can collectively be redeemed by the user. For example, 4.04 so-called “{U} World Dollars” have been granted to the user for correctly answering the questions 120 concerning the advertisement 116 in FIG. 9. A shared currency by multiple advertisers for the end customer to be redeemed is a key component to this interactive advertising media. The rewards granted to the user for answering the questions 120 concerning the advertisements 116 are saved in the user account hidden behind (e.g., shielding the user from the advertiser so the user can remain anonymous, yet earn the rewards from the advertisement) the EPC belonging to that user and added to a cumulative total that can be redeemed by the user.

In addition to the virtual currency granted to the user for correctly answering the questions 120 a single achievement point 126 may be also awarded to the user as a prize, although a plurality or no Achievement Points can optionally be awarded according to alternate embodiments. Achievement Points can be collected by the user and stored in the user account for performing various activities encouraged within the virtual environment. Achievement Points can be utilized to provide an incentive for users to perform activities within the virtual environment for which rewards that are redeemable for legal tender or other valuable consideration are not available. Users can compete amongst each other in collecting achievement points, and the quantity of Achievement Points owned by different users can be compared and publicly displayed, and the users optionally ranked, at the site 16 using the community terminal 34.

Users can redeem rewards stored in their user accounts by accessing the kiosk 40 located at the site 16, for example. As explained above, the kiosk 40 can be automated teller-like machine that dispenses cash or other valuable consideration to users redeeming their rewards. Users can insert an identification card into the kiosk 40 and optionally enter a security code in a manner analogous to that for withdrawing cash from a dispensing machine at a bank. Alternate embodiments involve users entering an identification code without a card, or otherwise verifying their identity when using the kiosk 40. The kiosk 40 communicates with a server hosting deposit account information to determine the value of rewards available for the user to redeem, and confirms that the user has not requested to redeem more than the total balance of rewards actually owned by the user. Because the rewards stored in the user account can be used as legal tender, the user has the option to redeem for a variety of different forms of payment including, but not limited to, cash or other legal tender, gift cards, credit cards, debit cards, vouchers, coupons and other discounts, other forms of virtual currency, and other forms of payment desired by the user that may be available.

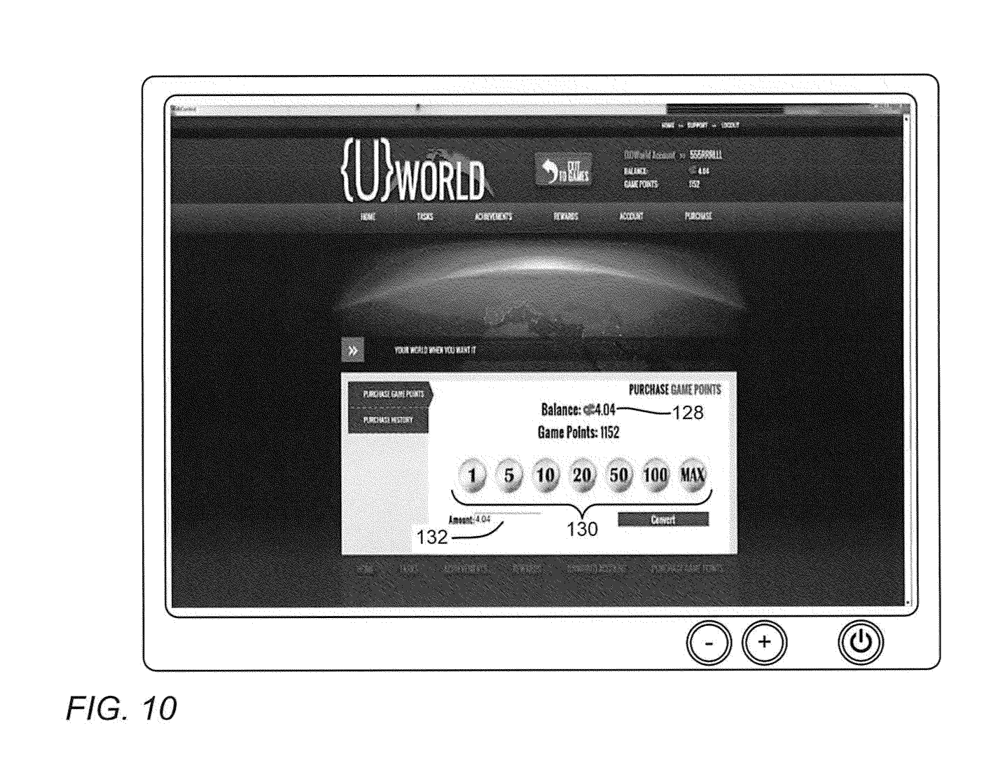

Rather than redeeming rewards stored in the user account for legal tender or other valuable consideration, users can elect to obtain additional Game Points within the virtual environment as shown in FIG. 10. The balance 128 of rewards stored in the user's account can be redeemed at a predetermined exchange rate for the Game Points. For the embodiment shown in FIG. 10, the {U} World Dollars are substantially equivalent to United States dollars, meaning each game point costs approximately $0.01 to purchase. According to the embodiment shown in FIG. 10, a plurality of different redemption denominations 130 are presented along with a custom entry field 132 where the user can manually enter the portion of the balance 128 the user desires to redeem for Game Points. The exchange rate for redeeming rewards in the user account in exchange for Game Points can optionally be equivalent to the exchange rate at which the rewards can be redeemed for legal tender, or can optionally provide a greater return when redeemed for Game Points instead of legal tender.

Illustrative embodiments have been described, hereinabove. It will be apparent to those skilled in the art that the above devices and methods may incorporate changes and modifications without departing from the general scope of this invention. It is intended to include all such modifications and alterations within the scope of the present invention. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer system for encouraging a user to observe, engage, or observe and engage an advertisement, the computer system comprising:
at least one non-transitory memory storing computer program code; and
at least one processor, wherein the at least one memory and the computer program code are configured to, with the at least one processor, cause the computer system at least to:
present the user with a virtual environment in which a game is to be played by the user,
monitor participation of the user in the game,
determine that the user is eligible to be presented with an interactive task involving the advertisement once the participation of the user in the game results in a game objective being achieved by the user,
grant the user access to the interactive task after the user has achieved the game objective,
present the user with the advertisement as part of the interactive task,
confirm that the user paid attention to a portion of the advertisement, and
grant to the user a reward in the virtual environment for paying attention to the portion of the advertisement, wherein the reward is redeemable at the discretion of the user to be used outside of the virtual environment as legal tender.

2. The computer system of claim 1, wherein the at least one memory and the computer program code are configured to, with the at least one processor, further cause the computer system to deduct a predetermined quantity of game credits from a user account belonging to the user for the participation of the user in the game.

3. The computer system of claim 2, wherein the game credits are not redeemable for legal tender, and are purchased by the user with legal tender.

4. The computer system of claim 2, wherein the predetermined quantity of the game credits deducted from the user account for the participation of the user in the game is variable, and selectable by the user.

5. The computer system of claim 4, wherein a relatively large quantity of the game credits is debited from the user account shortens a time required for the user to achieve the game objective from a time required for the user to achieve the game objective when a relatively small quantity of the game credits is debited from the user account.

6. The computer system of claim 2, wherein the at least one memory and the computer program code are configured to, with the at least one processor, further cause the computer system to occasionally, but not always, add a predetermined quantity of the game credits to the user account belonging to the user for the participation of the user in the game.

7. The computer system of claim 6, wherein the game credits are generally deducted from the user account faster than the game credits are added to the user account to establish a generally decreasing trend of the game credits in the user account.

8. The computer system of claim 2, wherein the game credits are further redeemable by the user for a predetermined quantity of game plays.

9. The computer system of claim 1, wherein the at least one memory and the computer program code are configured to, with the at least one processor, further cause the computer system to occasionally award the user achievement points that are stored in a user account belonging to the user in response to a plurality of different accomplishments by the user in the virtual environment.

10. The computer system of claim 9, wherein the at least one memory and the computer program code are configured to, with the at least one processor, further cause the computer system to compare the achievement points stored in the user account belonging to the user to a quantity of achievement points stored in other user accounts respectively belonging to other users, and transmitting a result of the comparison to be presented to the user and the other users to foster a competition between the user and the other users based on the achievement points.

11. The computer system of claim 1, wherein, after the user has achieved the game objective, the at least one memory and the computer program code are configured to, with the at least one processor, further cause the computer system to direct the user to a website on which at least one of a motion picture video, a still image, and an audible message included in the advertisement is presented to the user.

12. The computer system of claim 1, wherein the at least one memory and the computer program code are configured to, with the at least one processor, further cause the computer system to log the user into a website account belonging to the user based on information entered by the user to access the virtual environment including the game, when the user is directed to the website.

13. The computer system of claim 1, wherein the at least one memory and the computer program code are configured to, with the at least one processor, further cause the computer system to restrict access to the interactive task, thereby preventing completion of the task by the user to earn the reward before the user has achieved the game objective.

14. The computer system of claim 13, wherein the at least one memory and the computer program code are configured to, with the at least one processor, further cause the computer system to present the user with a question about the advertisement to confirm that the user paid attention to the portion of the advertisement, and receive an answer entered by the user.

15. The computer system of claim 14, wherein the at least one memory and the computer program code are configured to, with the at least one processor, further cause the computer system to determine whether the answer entered by the user is correct, and: (i) if the answer is correct, grant the user the reward, or (ii) if the answer is not correct, not grant the user the reward.

16. The computer system of claim 1, wherein the at least one memory and the computer program code are configured to, with the at least one processor, further cause the computer system to assign a value to the interactive task, wherein the value is variable within a range of possible values for the interactive task, and said possible values are indicative of a redemption value of the reward granted to the user for paying attention to the portion of the advertisement.

17. The computer system of claim 1, wherein the reward comprises a virtual currency within the virtual environment that can be redeemed by the user for at least one of:
legal tender that can be used outside of the virtual environment,
additional game credits that can be used in the virtual environment for the participation of the user in the game,
a gift certificate,
payment of a recurring subscription charge, and
another virtual currency redeemable in a different virtual environment.

18. The computer system of claim 1, wherein the at least one memory and the computer program code are configured to, with the at least one processor, further cause the computer system to monitor presentation of the advertisement to the user and a plurality of different users and maintain a record indicating at least one of:
a number of times the advertisement is presented,
demographic information specific to the user and each of the plurality of different users that are presented with the advertisement, and
an extent of an interaction between the user and the advertisement and between each of the plurality of additional users and the advertisement.

19. The computer system of claim 18, wherein the record maintain comprises the extent of the interaction between the user and the advertisement and between each of the plurality of additional users and the advertisement, and wherein a value of the reward granted to the user is based, at least in part, on the extent of the interaction between the user and the advertisement.
